(19) United States
(12) Patent Application Publication
(10) Pub. No.: US 2021/0207966 A1
(43) Pub. Date: Jul. 8, 2021

(54) METHOD, APPARATUS, AND COMPUTER PROGRAM PRODUCT FOR DYNAMIC ROUTE CALCULATIONS

(71) Applicant: HERE Global B.V., Eindhoven (NL)

(72) Inventor: James Fowe, Chicago, IL (US)

(73) Assignee: HERE Global B.V., Eindhoven (NL)

(21) Appl. No.: 16/733,640

(22) Filed: Jan. 3, 2020

(51) Int. Cl. G01C 21/34; G08G 1/0968

(52) U.S. Cl. CPC G01C 21/3415; G08G 1/096855; G08G 1/096844

(57) ABSTRACT

A method, apparatus, and computer program product are provided for dynamically updating route guidance for a vehicle. The method includes receiving an arrival tolerance indicator for a trip. The arrival tolerance indicator includes an arrival tolerance. The method also includes generating a projected route based on a fastest trip route calculated based on a beginning position of the trip and a destination of the trip. The method further includes calculating an alternative route for each of at least one alternative roadway as the vehicle approaches an intersection. The method still further includes creating a signal relating to at least one alternative route within the arrival tolerance in an instance at least one alternative route is within the arrival tolerance. A corresponding apparatus and computer program product are also provided.

### TECHNOLOGICAL FIELD

An example embodiment relates generally to a method and associated apparatus and computer program product for providing dynamic route guidance and, more particularly, to a method and associated apparatus and computer program product for providing alternative route mapping in real-time.

### BACKGROUND

Traditionally, route guidance is typically predicated on the fastest route to a destination. In navigation systems, one of the biggest challenges is the lack of flexibility in route choice. Most navigation systems select just one route or at most a few routes and expect the users to drive on those routes without diverging from said routes. Lack of flexibility in route guidance requires drivers or autonomous vehicles to follow along a route without regard for safety or scenery. For example, on multi-lane roads, a vehicle in the far-left lane may not be able to safely get to an exit on the right and these types of situations are not accounted for using traditional route guidance techniques.

### BRIEF SUMMARY

A method, apparatus, and computer program product are provided in accordance with an example embodiment in order to dynamically update route guidance for a vehicle. In an example embodiment, the method for dynamically updating route guidance for a vehicle is provided. The method includes receiving an arrival tolerance indicator for a trip. The arrival tolerance indicator includes an arrival tolerance. The method also includes generating a projected route based on a fastest trip route calculated based on a beginning position of the trip and a destination of the trip. The method further includes calculating an alternative route for each of at least one alternative roadway as the vehicle approaches an intersection. The method still further includes creating a signal relating to at least one alternative route within the arrival tolerance in an instance at least one alternative route is within the arrival tolerance.

In some embodiments, the method also includes altering the projected route of the vehicle to one of the alternative routes within the arrival tolerance in response to the signal. In some embodiments, the signal to alter the projected route of the vehicle is provided to a user interface. In some embodiments, the method also includes providing the projected route and at least one alternative routes to a user interface. In some embodiments, the arrival tolerance indicator includes at least one of a total travel time to destination or a target arrival time. In some embodiments, the arrival tolerance indicator is received from a user. In some embodiments, an alternative route is within the arrival tolerance in an instance the increase in the total time of travel to destination over the projected route is less than the arrival tolerance.

In another example embodiment, an apparatus is provided for dynamically updating route guidance for a vehicle. The apparatus includes at least one processor and at least one non-transitory memory including computer program code instructions, the computer program code instructions configured to, when executed, cause the apparatus to receive an arrival tolerance indicator for a trip. The computer program code instructions are also configured to, when executed, cause the apparatus to generate a projected route based on a fastest trip route calculated based on a beginning position of the trip and a destination of the trip. The computer program code instructions are further configured to, when executed, cause the apparatus to calculate an alternative route for each of at least one alternative roadway as the vehicle approaches an intersection. The computer program code instructions are still further configured to, when executed, cause the apparatus to create a signal relating to at least one alternative route within the arrival tolerance in an instance at least one alternative route is within the arrival tolerance.

In some embodiments, the computer program code instructions are also configured to, when executed, cause the apparatus to alter the projected route of the vehicle to one of the alternative routes within the arrival tolerance in response to the signal. In some embodiments, the signal to alter the projected route of the vehicle is provided to a driver of the vehicle. In some embodiments, the computer program code instructions are also configured to, when executed, cause the apparatus to provide the projected route and at least one alternative routes to a user interface. In some embodiments, the arrival tolerance indicator includes at least one of a total travel time to destination or a target arrival time. In some embodiments, the arrival tolerance indicator is received from a user. In some embodiments, an alternative route is within the arrival tolerance in an instance the increase in the total time of travel to destination over the projected route is less than the arrival tolerance.

In still another example embodiment, a computer program product is provided. The computer program product includes at least one non-transitory computer-readable storage medium having computer-executable program code portions stored therein, the computer-executable program code portions including program code instructions configured to receive an arrival tolerance indicator for a trip. The computer-executable program code portions also include program code instructions configured to generate a projected route based on a fastest trip route calculated based on a beginning position of the trip and a destination of the trip. The computer-executable program code portions further include program code instructions configured to calculate an alternative route for each of at least one alternative roadway as the vehicle approaches an intersection. The computer-executable program code portions still further include program code instructions configured to create a signal relating to at least one alternative route within the arrival tolerance in an instance at least one alternative route is within the arrival tolerance.

In some embodiments, the program code instructions are further configured to alter the projected route of the vehicle to one of the alternative routes within the arrival tolerance in response to the signal. In some embodiments, the signal to alter the projected route of the vehicle is provided to a driver of the vehicle. In some embodiments, the program code instructions are further configured to provide the projected route and at least one alternative routes to a user interface. In some embodiments, the arrival tolerance indicator is received from a user and the arrival tolerance indicator includes at least one of a total travel time to destination or a target arrival time. In some embodiments, an alternative route is within the arrival tolerance in an instance the increase in the total time of travel to destination over the projected route is less than the arrival tolerance.

In still another example embodiment, an apparatus for dynamically updating route guidance for a vehicle is provided. The apparatus includes means for receiving an arrival tolerance indicator for a trip. The arrival tolerance indicator includes an arrival tolerance. The apparatus also includes means for generating a projected route based on a fastest trip route calculated based on a beginning position of the trip and a destination of the trip. The apparatus further includes means for calculating an alternative route for each of at least one alternative roadway as the vehicle approaches an intersection. The apparatus still further includes means for creating a signal relating to at least one alternative route within the arrival tolerance in an instance at least one alternative route is within the arrival tolerance.

In some embodiments, the apparatus also includes means for altering the projected route of the vehicle to one of the alternative routes within the arrival tolerance in response to the signal. In some embodiments, the signal to alter the projected route of the vehicle is provided to a user interface. In some embodiments, the apparatus also includes means for providing the projected route and at least one alternative routes to a user interface. In some embodiments, the arrival tolerance indicator includes at least one of a total travel time to destination or a target arrival time. In some embodiments, the arrival tolerance indicator is received from a user. In some embodiments, an alternative route is within the arrival tolerance in an instance the increase in the total time of travel to destination over the projected route is less than the arrival tolerance.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus configured in accordance with an example embodiment of the present disclosure;

FIG. 2 is a flowchart illustrating the operations performed, such as by the apparatus of FIG. 1, in accordance with an example embodiment of the present disclosure;

FIGS. 3A-3B are schematic drawings of the decision tree at different intersections along a trip from a beginning position to a destination;

FIG. 4 illustrates an example user interface provided in accordance with an example embodiment of the present disclosure; and

FIGS. 5A-5B illustrate example embodiments of the present disclosure used for multi-lane driving environments.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

A method, apparatus, and computer program product are provided in accordance with an example embodiment of the present disclosure for dynamically updating route guidance for a vehicle. In an example embodiment, the method, apparatus, and computer program are provided for facilitating autonomous and semi-autonomous route guidance. Embodiments of the present disclosure allow for a flexible, more robust routing system to provide alternate routes during operations before taking the route itself. Various embodiments allow for autonomous vehicles and/or drivers to know various optional routes that leads them to the same destination within the a given arrival tolerance. Although described in conjunction with autonomous and semi-autonomous vehicles, the method, apparatus, and computer program product of an example embodiment may also be utilized in conjunction with manually-driven vehicles.

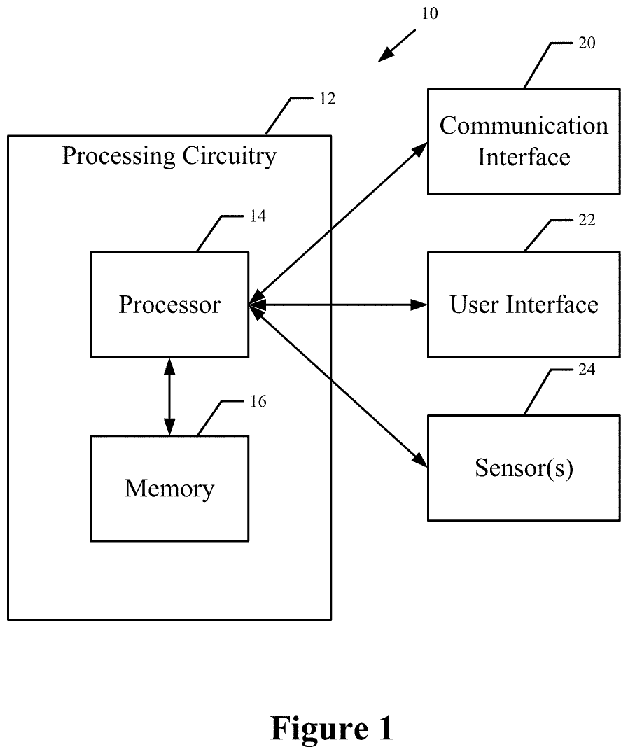

FIG. 1 is a schematic diagram of an example apparatus configured for performing any of the operations in accordance with an example embodiment as described herein. Apparatus 10 may be embodied by or associated with any of a variety of computing devices that include or are otherwise associated with a device configured for providing an advanced driver assistance features. For example, the computing device may be an Advanced Driver Assistance System module (ADAS) which may at least partially control autonomous or semi-autonomous features of a vehicle; however embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. In one embodiment the apparatus 10 is embodied or partially embodied by an electronic control unit of a vehicle that supports safety-critical systems such as the powertrain (engine, transmission, electric drive motors, etc.), steering (e.g., steering assist or steer-by-wire), and braking (e.g., brake assist or brake-by-wire). Alternatively, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 10 may include, be associated with, or may otherwise be in communication with a processing circuitry 12, which includes a processor 14 and a memory device 16, a communication interface 20, a user interface 22, and one or more sensors 24. In some embodiments, the processor 14 (and/or co-processors or any other processing circuitry assisting or otherwise associated with the processor) may be in communication with the memory device 16 via a bus for passing information among components of the apparatus. The memory device 16 may be non-transitory and may include, for example, one or more volatile and/or non-volatile memories. In other words, for example, the memory device 16 may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present disclosure. For example, the memory device could be configured to buffer input data for processing by the processor. Additionally or alternatively, the memory device could be configured to store instructions for execution by the processor.

The processor 14 may be embodied in a number of different ways. For example, the processor 14 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 14 may be configured to execute instructions stored in the memory device 16 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present disclosure by further configuration of the processor by instructions for performing the algorithms and/or operations described herein. The processor may include, among other things, a clock, an arithmetic logic unit (ALU) and logic gates configured to support operation of the processor.

The apparatus 10 of an example embodiment may also include or otherwise be in communication with a user interface 22. The user interface may include a touch screen display, a speaker, physical buttons, and/or other input/output mechanisms. In an example embodiment, the processor 14 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 16, and/or the like). The user interface may be embodied in the same housing as the processing circuitry, such as in a navigation system.

The apparatus 10 of an example embodiment may also optionally include a communication interface 20 that may be any means such as a device or circuitry embodied in either hardware or a combination of hardware and software that is configured to receive and/or transmit data from/to other electronic devices in communication with the apparatus, such as by near field communication (NFC) or other proximity-based techniques. Additionally or alternatively, the communication interface may be configured to communicate via cellular or other wireless protocols including Global System for Mobile Communications (GSM), such as but not limited to Long Term Evolution (LTE). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication for vehicle to vehicle or vehicle to infrastructure wireless links. In example embodiments, the communication interface 20 may receive and transmit lane data for one or more lanes from a traffic service provider (TSP). For example, communication interface 20 may receive lane data for an HOV lane near the vehicle (e.g., an adjacent lane).

The apparatus 10 may be equipped, or otherwise in communication with one or more sensors 24, such as a global positioning system (GPS), accelerometer, image sensor/camera, LiDAR (Light Distancing and Ranging) sensor, radar, and/or gyroscope. Any of the sensors may be used to sense information regarding the movement, positioning, or conditions of the vehicle and/or surroundings. For example, a sensor, or set of sensors, may be used to distance between vehicles on a road. In some example embodiments, such sensors may be implemented in a vehicle or other remote apparatus, and the information detected may be transmitted to the apparatus 10, such as by near field communication (NFC) including, but not limited to, Bluetooth™ communication, or the like. In some embodiments, the sensory circuitry may be connected, at least in part, by a wired connection. In various embodiments, the sensor(s) 24 may be carried by a vehicle.

Autonomous driving has become a focus of recent technology with recent advances in machine learning, computer vision, and computing power able to conduct real-time sensing of a vehicle's condition and environment. With both autonomous and non-autonomous vehicles, route guidance based on methods other than fastest time to destination may be difficult as other factors, such as safety, may be difficult to calculate for a route. In this regard, a route guidance using dynamic updating in combination with an arrival tolerance allows for other factors to be considered beyond the traditional “fastest” route to destination.

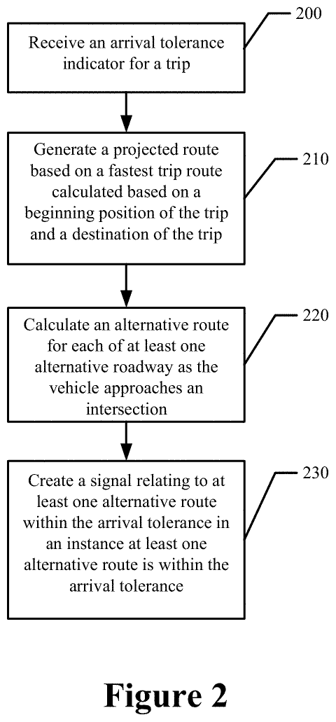

Referring now to FIG. 2, the operations performed by the apparatus 10 of an example embodiment of the present disclosure includes means, such as the processing circuitry 12, the processor 14 or the like, for dynamically updating route guidance for a vehicle. In an example embodiment, detailed herein, the method, apparatus, and computer program product could be used in relation to vehicles including both autonomous vehicles and manually-operated vehicles.

As shown in block 200 of FIG. 2, the apparatus 10 includes means, such as the processing circuitry 12, the processor 14 or the like, for receiving an arrival tolerance indicator for a trip. In various embodiments, the arrival tolerance indicator comprises an arrival tolerance. In some embodiments, the arrival tolerance indicator may be at least one of a total travel time and/or a target arrival time. In some embodiments, the apparatus 10 includes means, such as the processing circuitry 12, the communication interface 20, the user interface 22, or the like, for receiving the arrival tolerance indicator for the trip. For example, a user may input an arrival tolerance indicator into a navigation system.

In some embodiments, the apparatus 10 may include means, such as the communication interface 20, for receiving a standard arrival tolerance indicator. For example, the standard arrival tolerance may be zero. In some embodiments, the apparatus 10 includes means, such as the memory device 16, for storing the standard arrival tolerance indicator. In some embodiments, the apparatus 10 may allow for a standard arrival tolerance to be set by a user and/or a manufacturer. For example, in an instance the user does not input an arrival tolerance for a specific trip, the apparatus 10 may use the standard arrival tolerance as the arrival tolerance for the trip.

Referring now to Block 210 of FIG. 2, the apparatus 10 includes means, such as the processing circuitry 12, the processor 14 or the like, for generating a projected route based on a fastest trip route calculated from a beginning position of the trip and a destination of the trip. In some embodiments, the “fastest” trip route may be determined using existing filters (e.g., avoid toll roads). In some embodiments, the apparatus 10 includes means for receiving the beginning position of the trip and/or the destination of the trip. In some embodiments, the apparatus 10 includes means, such as the sensor 24, the processing circuitry 12, or the like, for determining the beginning position of the trip based on the position of the apparatus 10 (e.g., location of vehicle). In some embodiments, the apparatus 10 includes means, such as the communication interface 20, the user interface 22, or the like, for receiving the beginning position of the trip from a user (e.g., then start the operations herein when the apparatus 10 reaches the beginning position). In some embodiments, the apparatus 10 includes means, such as the processing circuitry 12, for obtaining the projected route via an A* search.

Referring now to Block 220 of FIG. 2, the apparatus 10 includes means, such as the processing circuitry 12, the processor 14 or the like, for calculating an alternative route for each of at least one alternative roadway as the vehicle approaches an intersection. In some embodiments, alternative routes may be calculated at each intersection along the route of the vehicle. Alternatively, alternative routes may only be calculated at certain intersections. For example, alternative routes may only be calculated at major intersections where there are a certain number of alternative roadways. In some embodiments, an intersection may be defined in an instance a plurality of roadways come together allowing a driver to have a plurality of driving options. In some embodiments, the apparatus 10 may be configured to calculate the alternative route(s) at or near the intersection. For example, as the vehicle approaches each intersection along a trip, the apparatus 10 may be configured to determine the alternative route for each alternative roadway at that intersection. In some embodiments, the alternative routes may be calculated by calculating the fastest route from the intersection to the destination in an instance the vehicle takes a given alterative roadway at the intersection (e.g., as the fastest rout is calculated for the projected route). In some embodiments, the apparatus 10 includes means, such as the processing circuitry 12, for obtaining the alternative routes by performing additional A* searches for each alterative roadway. In some embodiments, the apparatus 10 includes means, such as the processing circuitry 12, for determining if any of the alternative routes are within the arrival tolerance. In an example embodiment, an alternative route is within the arrival tolerance in an instance the difference between the alternative route and the projected route is less than the arrival tolerance. For example, in an instance an alternative route adds 5 minutes to the trip and the arrival tolerance is 15 minutes, the alternative route would be within the arrival tolerance. In some embodiments, the apparatus 10 may be configured with a pre-set arrival tolerance. For example, a pre-set arrival tolerance may be zero, in which case the apparatus 10 may select the fastest route.

Referring now to Block 230 of FIG. 2, the apparatus 10 includes means, such as the processing circuitry 12, the processor 14 or the like, for creating a signal relating to at least one alternative route within the arrival tolerance in an instance at least one alternative route is within the arrival tolerance. In some embodiments, the signal may be provided to a user (e.g., driver and/or passenger) and/or an autonomous vehicle processor. The signal provided may be any response by the apparatus, such as the processing circuitry 12, the processor 14 or the like, to the determination of one or more alternative routes being within the arrival tolerance. For autonomous vehicles, this signal may be configured to cause a vehicle to alter the projected route of the vehicle to one of the other alternative routes within the arrival tolerance. In some embodiments, the user may be able to determine whether an autonomous vehicle will automatically alter the projected route. For autonomous vehicles that retain human driver features, the apparatus, such as the processor 12, of an example embodiment may allow for a driver to route alterations. In some embodiments, autonomous vehicles with a driver override may notify the driver of the impending alteration in route and permit driver override, if desired.

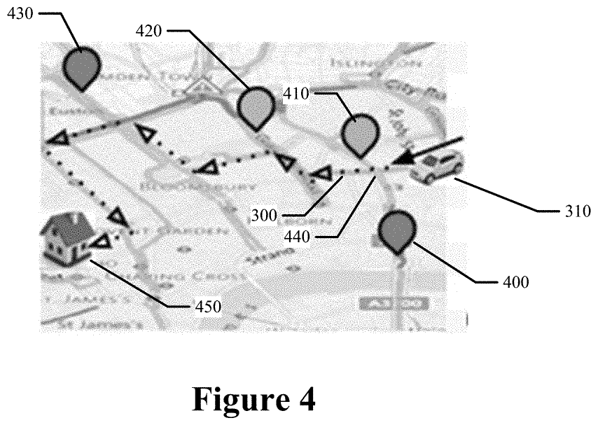

In some embodiments, for semi-autonomous or non-autonomous, manually-operated vehicles, the signal may be configured to cause a message to be communicated to the driver of the vehicle. The message may be provided in various forms and may notify the driver of the merging information. In various embodiments, the message may be audible and/or visual. In some embodiments, the message may be communicated through pre-existing interfaces, such as a navigation system, infotainment system, or a speaker system. In some embodiments, such as shown in FIG. 4, the apparatus 10 includes means, such as the processing circuitry 12, the communication interface 20, the user interface 22, or the like, for displaying one or more alternative routes along with the projected route on a map. In various embodiments, the information provided in the message may include additional time added to route, an indication of whether an alternative route is within the arrival tolerance, and/or the like. Notwithstanding the foregoing examples, there are many ways to communicate the signal to the driver.

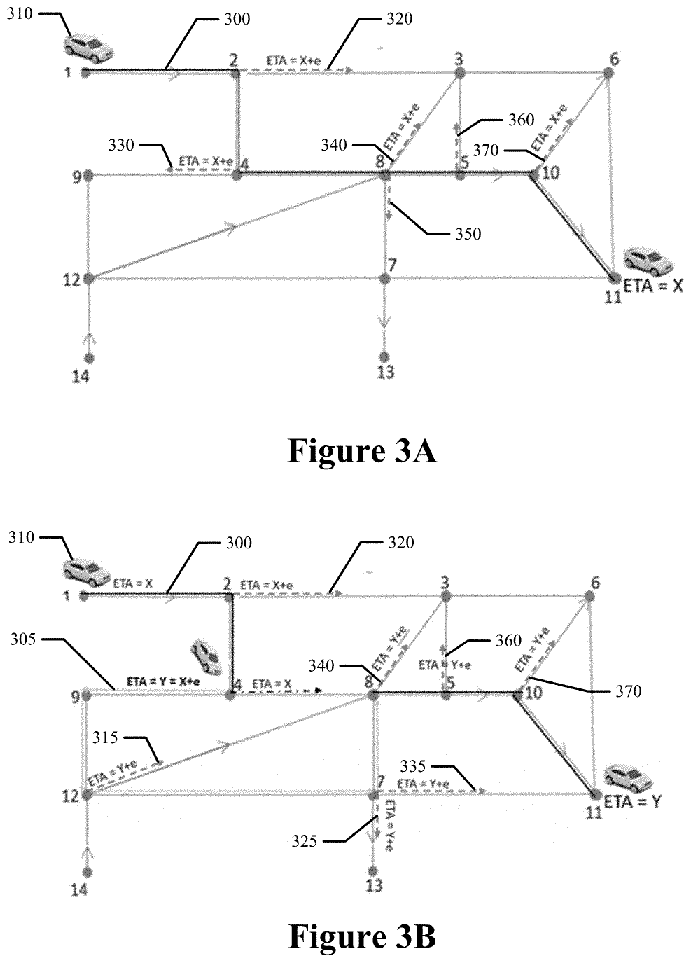

Referring now to FIG. 3A, a projected route 300 is shown in accordance with an example embodiment of the present disclosure. As discussed in FIG. 2, the projected route may be calculated from the beginning position (e.g., node 1) to the destination (e.g., node 11). For example, as shown, the projected route may route 300. In various embodiments, the projected route may be determined initially (e.g., at the beginning position). As an example, during traversal of route 300, the apparatus 10 may preform the operations discussed in FIG. 2 at each intersection. As the vehicle 310 approaches the intersection at node 2, there is one alternative roadway (roadway heading in the direction of node 3 shown by arrow 320). As shown, the apparatus 10 may, upon approaching the intersection at node 2, calculate the alternative route along said alternative roadway (e.g., the fastest route to destination 11 in an instance the alternative roadway 320 is taken). In some embodiments, the alternative route may be compared to the arrival tolerance to determine whether the alternative route may be within the arrival tolerance of the projected route. For example, in an instance the arrival tolerance may be 30 minutes and an alternative route adds 14 minutes to the estimated time of arrival (ETA) over the projected route, then the alternative route would be within the arrival tolerance. In such an embodiment, the signal discussed in reference to Block 230 of FIG. 2 above may be created. As shown in the example of FIG. 3A, the vehicle 310 may continue along projected route to the destination without changing of the route. During the traversal of the projected route 300, the operations discussed for determining whether an alternative route along alternative roadway 320 was within the arrival tolerance may be repeated at each intersection. For example, the alternative route may be determined for alternative roadway 330 as the vehicle 310 approaches node 4, alternative roadways 340 and 350 as the vehicle 310 approaches node 8, alternative roadway 370 as the vehicle 310 approaches node 5, and alternative roadway 370 as the vehicle 310 approaches node 10.

Referring now to FIG. 3B, the vehicle 310 may begin along the same projected route 300 discussed in FIG. 3A until the vehicle 310 reaches the intersection at node 4, at which point the vehicle may, upon receiving an indication that the alternative route 305 was within the arrival tolerance, divert to alternative route 305 in the direction of node 9. In such an embodiment, the alternative route 305 now becomes the projected route (e.g., the alternative route 305 replaces the projected route 300). In such an instance, the arrival tolerance may be updated based on the change in arrival time. For instance, as shown in FIG. 3B, the ETA of the projected route was X and the alternative route 305 has an ETA of Y, wherein the difference between the ETA of the projected route 300 and the ETA of the alternative route 305 is defined as “e”. In some embodiments, the arrival tolerance may be adjusted based on the changing of routes. In some embodiments, the difference between the routes ETA (e) may be subtracted from the original arrival tolerance to create the updated arrival tolerance. For example, in an instance the original arrival tolerance was 30 minutes and the alternative route adds 14 minutes to the ETA, then the updated arrival tolerance is 16 minutes.

In various embodiments, the updated arrival tolerance may be used as the arrival tolerance in subsequent determinations along a trip. For example, in an instance a subsequent alternative route may add 20 minutes to the route and the updated arrival tolerance is 16 minutes as in the example above, the alternative route would be out of the arrival tolerance. As shown, the operations discussed herein may be performed at each subsequent intersection along the alternative route 305 (e.g., for alternative roadway 315 at node 12, alternative roadways 325 and 335 at node 7). In some embodiments, the alternative route (e.g., route 305) may overlap with the original projected route (e.g., route 305). In various embodiments, the operations discussed herein may only be performed at or near an intersection (e.g., node) for that specific intersection. (e.g., the alternative routes may not all be calculated at the beginning of the trip).

Referring now to FIG. 4, an example user interface is provided in accordance with an example embodiment of the present disclosure. In this example, the vehicle 310 may be travelling along projected route 300 to destination 350. As such, alternative roadways along the projected route may be marked with different color markers (e.g., marker 420 may be green, marker 410 may be yellow, and markers 400 and 430 may be red markers) to indicate whether the alternative routes were within the arrival tolerance. For example, the green marker 420 may indicate that the alternative route is safely within the arrival tolerance, the yellow marker 410 may indicate that the alternative route is barely within the arrival tolerance, and the red markers 400, 430 may indicate that the alternative route is not within the arrival tolerance.

In an example embodiment, the driver and/or autonomous vehicle processor may use the information to determine whether to take an alternative route. In some embodiments, the determination of whether the alternative route is within the arrival tolerance may be performed at or near the intersection for which the alternative route may be taken. As such, the markers (e.g., 400, 410, 420, and 430) may not be presented until the vehicle 310 approaches the intersection. For example, in an instance the vehicle 310 approaches intersection 440, the markers 400 and 410 may be displayed to indicate the applicability of a given alternative route. In such an example, markers 420 and 430 may not be shown until the vehicle 310 approaches the intersection including the given alternative roadway. In various embodiments, the user interface 22 may display the information relating to alternative routes in different ways. In some embodiments, such as autonomous vehicles, the information relating to the alternative routes may be used by the processor to determine whether to take an alternative route and may not provide the information to the user.

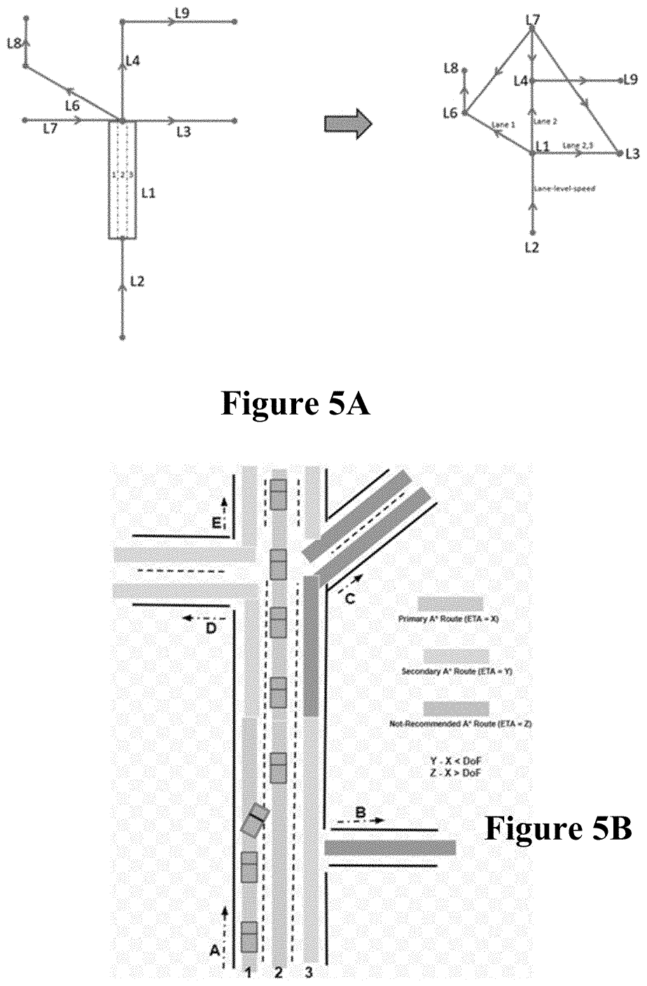

Referring now to FIGS. 5A and 5B, in some embodiments, the apparatus 10 may include means, such as the processing circuitry 12, the processor 14, or the like, for completing the operations discussed herein for a multi-lane road. For example, in an instance, such as shown in FIG. 5A, where there are three lanes of traffic, the apparatus 10 may include means, such as the processing circuitry 12, for determining a projected route and/or alternative routes, based on the specific lanes of travel.

As shown, roadway L1 may have three lanes (Lane 1, Lane 2, and Lane 3). Additionally, L6 is a potential roadway along the left side of roadway L1 (e.g., an exit to the left on an interstate), L4 is a potential roadway continuing straight (e.g., continuing along an interstate), and L3 is a potential roadway along the right side of the roadway (e.g., an exit to the right on an interstate). Referring now to FIG. 5B, roadway L6 may correspond with roadway D, roadway L4 may correspond to roadway E, and roadway L3 may correspond to roadway C. In the example shown in FIG. 5A, the apparatus 10 may create routes (e.g., projected routes and/or alternative routes) for each roadway using the one or more lanes of L1 used to turn onto a given roadway. For example, as shown, roadway L6 may be accessed via Lane 1, roadway L4 may be accessed via Lane 2, and roadway L3 may be accessed by either Lane 2 or 3. In various embodiments, the apparatus 10 may include means, such as the processing circuitry 12, for determining the projected route and/or alternative route(s) of a trip using lane-level data. In the example, the apparatus 10 may use lane level data to determine the ETA of a given route. For example, the vehicle average speed of a given lane may increase or decrease the ETA for a route. In an example where a vehicle is travelling along Lane 1 of L1 and the projected route is along roadway L6, then the apparatus 10 may determine the alterative route of the other roadways (e.g., L3 and L4) including the time required to merge into a given lane required to reach of the alternative routes. As shown in FIG. 5B, some lanes, such as Lane 3 may be slow approaching the turn for roadway C (e.g., roadway L3 of FIG. 5A). In the example shown, the apparatus 10 has determined that continuing along Lane 2 in the direction of roadway E (L4) is the projected route. Additionally, the apparatus 10 has determined, such as by the processing circuitry 12, that the alternative route along roadway D (L6) from Lane 1 may be within the arrival tolerance. In some embodiments, the driver and/or autonomous vehicle processor may determine that the vehicle travelling along the alternative route of roadway D may be preferred over the projected route. For example, in an instance the vehicle is in Lane 1, it may be safer to remain in Lane 1 and take the alternative route instead of trying to merge into Lane 2. In this example, the apparatus 10 has determined, such as by the processing circuitry 12, that the alternative route along roadway C (L3) from Lane 3 is not within the arrival tolerance and therefore a vehicle in Lane 3 may need to merge into Lanes 1 or 2. In various embodiments, the operations discussed in reference to FIG. 2 may be used to determine lane level projected routes and/or alternative routes.

Various embodiments of methods, apparatuses, and computer program products are provided in accordance with an example embodiment of the present disclosure for dynamically updating route guidance for a vehicle. In an example embodiment, the method, apparatus, and computer program are provided for facilitating autonomous and semi-autonomous route guidance. Embodiments of the present disclosure allow for a flexible, more robust routing system to provide alternate routes during operations before taking the route itself. Various embodiments allow for autonomous vehicles and/or drivers to know various optional routes that leads them to the same destination within the a given arrival tolerance. Although described in conjunction with autonomous and semi-autonomous vehicles, the method, apparatus, and computer program product of an example embodiment may also be utilized in conjunction with manually-driven vehicles.

As described above, FIG. 2 illustrates a flowchart of an apparatus 10, method, and computer program product according to example embodiments of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 16 of a software development test platform employing an embodiment of the present disclosure and executed by the processing circuitry 12, the processor 14 or the like of the software development test platform. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method of dynamically updating route guidance for a vehicle, the method comprising:
receiving an arrival tolerance indicator for a trip, wherein the arrival tolerance indicator comprises an arrival tolerance;
generating a projected route based on a fastest trip route calculated based on a beginning position of the trip and a destination of the trip;
calculating an alternative route for each of at least one alternative roadway as the vehicle approaches an intersection; and
in an instance at least one alternative route is within the arrival tolerance, creating a signal relating to at least one alternative route within the arrival tolerance.

2. The method of claim 1, further comprising altering the projected route of the vehicle to one of the alternative routes within the arrival tolerance in response to the signal.

3. The method of claim 2, wherein the signal to alter the projected route of the vehicle is provided to a user interface.

4. The method of claim 1, further comprising providing the projected route and at least one alternative routes to a user interface.

5. The method of claim 1, wherein the arrival tolerance indicator comprises at least one of a total travel time to destination or a target arrival time.

6. The method of claim 1, wherein the arrival tolerance indicator is received from a user.

7. The method of claim 1, wherein an alternative route is within the arrival tolerance in an instance the increase in the total time of travel to destination over the projected route is less than the arrival tolerance.

8. An apparatus for dynamically updating route guidance for a vehicle, the apparatus comprising at least one processor and at least one non-transitory memory including computer program code instructions, the computer program code instructions configured to, when executed, cause the apparatus to:
receive an arrival tolerance indicator for a trip;
generate a projected route based on a fastest trip route calculated based on a beginning position of the trip and a destination of the trip;
calculate an alternative route for each of at least one alternative roadway as the vehicle approaches an intersection; and
in an instance at least one alternative route is within the arrival tolerance, create a signal relating to at least one alternative route within the arrival tolerance.

9. The apparatus of claim 8, wherein the computer program code instructions are further configured to, when executed, cause the apparatus to alter the projected route of the vehicle to one of the alternative routes within the arrival tolerance in response to the signal.

10. The apparatus of claim 9, wherein the signal to alter the projected route of the vehicle is provided to a driver of the vehicle.

11. The apparatus of claim 8, wherein the computer program code instructions are further configured to, when executed, cause the apparatus to provide the projected route and at least one alternative routes to a user interface.

12. The apparatus of claim 8, wherein the arrival tolerance indicator comprises at least one of a total travel time to destination or a target arrival time.

13. The apparatus of claim 8, wherein the arrival tolerance indicator is received from a user.

14. The apparatus of claim 8, wherein an alternative route is within the arrival tolerance in an instance the increase in the total time of travel to destination over the projected route is less than the arrival tolerance.

15. A computer program product comprising at least one non-transitory computer-readable storage medium having computer-executable program code portions stored therein, the computer-executable program code portions comprising program code instructions configured to:
receive an arrival tolerance indicator for a trip;
generate a projected route based on a fastest trip route calculated based on a beginning position of the trip and a destination of the trip;
calculate an alternative route for each of at least one alternative roadway as the vehicle approaches an intersection; and
in an instance at least one alternative route is within the arrival tolerance, create a signal relating to at least one alternative route within the arrival tolerance.

16. The computer program product of claim 15, wherein the program code instructions are further configured to alter the projected route of the vehicle to one of the alternative routes within the arrival tolerance in response to the signal.

17. The computer program product of claim 16, wherein the signal to alter the projected route of the vehicle is provided to a driver of the vehicle.

18. The computer program product of claim 15, wherein the program code instructions are further configured to provide the projected route and at least one alternative routes to a user interface.

19. The computer program product of claim 15, wherein the arrival tolerance indicator is received from a user and the arrival tolerance indicator comprises at least one of a total travel time to destination or a target arrival time.

20. The computer program product of claim 15, wherein an alternative route is within the arrival tolerance in an instance the increase in the total time of travel to destination over the projected route is less than the arrival tolerance.
